(19) United States
(12) Patent Application Publication
(10) Pub. No.: US 2010/0114619 A1
(43) Pub. Date: May 6, 2010

(54) CUSTOMIZED TRANSFORMATION OF FREE-FORM BUSINESS CONCEPTS TO SEMANTICALLY RICH BUSINESS MODELS

(75) Inventors: Dorian Birsan, Toronto (CA); Luc Chamberland, Toronto (CA); Allen V.C. Chan, Markham (CA); Ian C. Kennedy, Antigonish (CA); Nathan Kwan, Thornhill (CA); Randolph P. Williams, Markham (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/261,445

(22) Filed: Oct. 30, 2008

(51) Int. Cl. G06Q 10/00

(52) U.S. Cl. 705/7

(57) ABSTRACT

A computer-implemented method for transforming a free-form process diagram into a semantically rich business model based on heuristics. The method includes generating and storing predefined mappings between informal elements to be used in a free-form process diagram and formal elements associated with a semantically rich business model, in a storage medium, receiving a free-form process diagram to be transformed, automatically detecting and mapping the informal elements of the free-form process diagram to the stored predefined-mappings, automatically detecting and mapping connectors positioned between the informal elements of the free-form process diagram, and obtaining user input from a user for generating user-defined mappings for mapping unrecognizable informal elements of the free-form process diagram to formal elements and transforming the unrecognized informal elements into formal elements based on the user-defined mappings.

### BACKGROUND

The present invention relates to transformation of free-form process diagrams into semantically rich business process models, and more specifically, to transformation of free-form process diagrams into semantically rich business process models using domain knowledge-based heuristic.

Business processes are a series of related business activities aimed at achieving one or more business objectives in a measurable manner. Typical business processes include receiving orders, marketing services, selling products, delivering services, distributing products, invoicing for services, and accounting for money received, for example. Models are developed to exposed and explore concepts within a business process. Today, business users utilize high level tools to express the concepts in a free-form graphical format such as Microsoft Powerpoint or Visio. These concepts need to be modeled, simulated, and enhanced. Typically, a business analyst takes business user's ideas realized by free-form process diagrams and manually creates the business artefacts using formal modeling software (or an IT developer interprets ideas in an implementation from direct interaction with the business user. Problems may occur in that the analyst may misinterpret the user's intended meaning of the elements within the free-form process diagrams.

Further, conventional automated methods automate the transforming of free-form diagrams into business models by having a predefined mapping of informal elements to business model elements. These conventional methods are often inflexible concerning handling of contextual information.

### SUMMARY

According to one embodiment of the present invention, a computer-implemented method for transforming a free-form process diagram into a semantically rich business model based on heuristics is provided. The method includes generating and storing predefined mappings between informal elements to be used in a free-form process diagram and formal elements associated with a semantically rich business model, in a storage medium, receiving a free-form process diagram to be transformed, automatically detecting and mapping the informal elements of the free-form process diagram to the stored predefined-mappings, automatically detecting and mapping connectors positioned between the informal elements of the free-form process diagram, and obtaining user input from a user for generating user-defined mappings for mapping unrecognizable informal elements of the free-form process diagram to formal elements and transforming the unrecognized informal elements into formal elements based on the user-defined mappings.

According to another embodiment of the present invention, a computer program product implementing the above-mentioned method is also provided.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a flow diagram illustrating a method for transforming a free-form process diagram into a semantically rich business model that can be implemented within embodiments of the present invention.

FIG. 2 is a diagram illustrating an example of configurable mapping of informal elements of a free-form process diagram to formal elements within a business modeler that can be implemented within embodiments of the present invention.

FIG. 3 is a diagram illustrating another example of configurable mapping of informal elements of a free-form process diagram to formal elements within a business modeler can be implemented within embodiments of the present invention.

FIG. 4 is a diagram illustrating another example of configurable mapping of informal elements of a free-form process diagram to formal elements within a business modeler can be implemented within embodiments of the present invention.

FIG. 5 is a diagram illustrating a transformation of an informal element within a free-form process diagram to a formal element within a semantically rich business model that can be implemented within an embodiment of the present invention.

FIGS. 6A and 6B are diagrams illustrating examples of transformation of informal task and connector elements to formal elements that can be implemented within embodiments of the present invention.

FIG. 7 is diagram illustrating another example of transformation of informal task and connector elements to formal elements that can be implemented within embodiments of the present invention.

FIG. 8 is a schematic block diagram of a general-purpose computer suitable for practicing the present invention embodiments.

### DETAILED DESCRIPTION

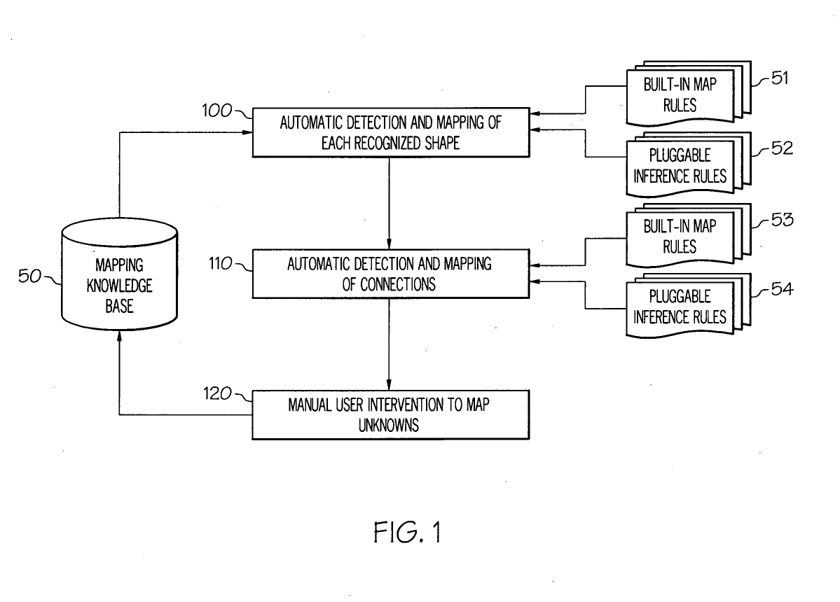

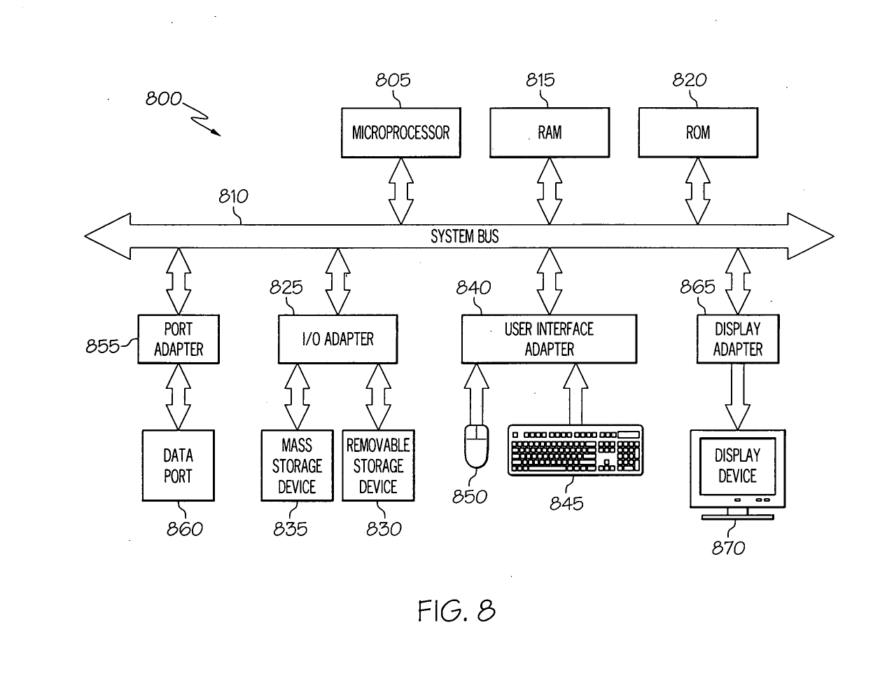

With reference now to FIG. 1, there is flow diagram for transforming a free-form process diagram into a semantically rich business model that can be implemented within an embodiment of the present invention. According to an embodiment of the present invention, the operations performed in FIG. 1, are performed via the use of a business process modeling tool (hereinafter referred to as a “business modeler”) that enables a user to model, simulate and analyze the user's business processes including the properties of the process activities such as specific tasks, roles, and dependencies. According to an embodiment of the present invention, the business modeler may be a plug-in installable via a computer as depicted in FIG. 8, for example. However, the present invention is not limited to any particular implementation and any suitable implementation may be used.

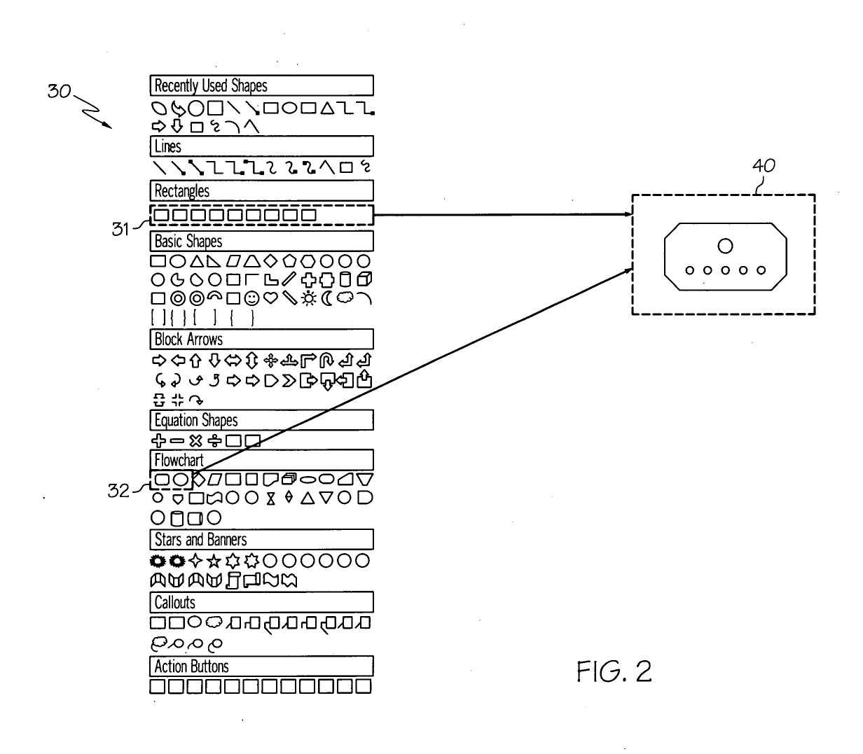

Referring to FIG. 1, predefined mappings between informal elements provided in a palette (as depicted in FIG. 2, for example) in an informal drawing tool such as Microsoft PowerPoint, for forming a free-form process diagram and formal elements associated with a semantically rich business model within the business modeler are generated and stored in a storage medium, such as a mapping knowledge base 50. According to one embodiment, at least one informal element is mapped to at least one formal element. The predefined mappings are included in a set of built-in map rules 51. Examples of predefined, configurable mappings are shown in FIGS. 2 through 4, for example.

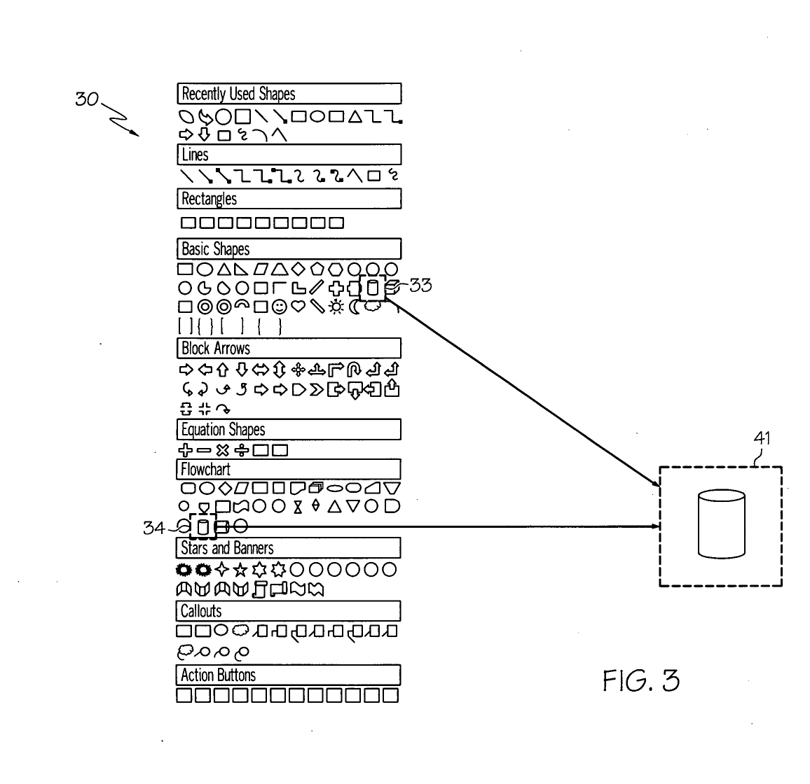

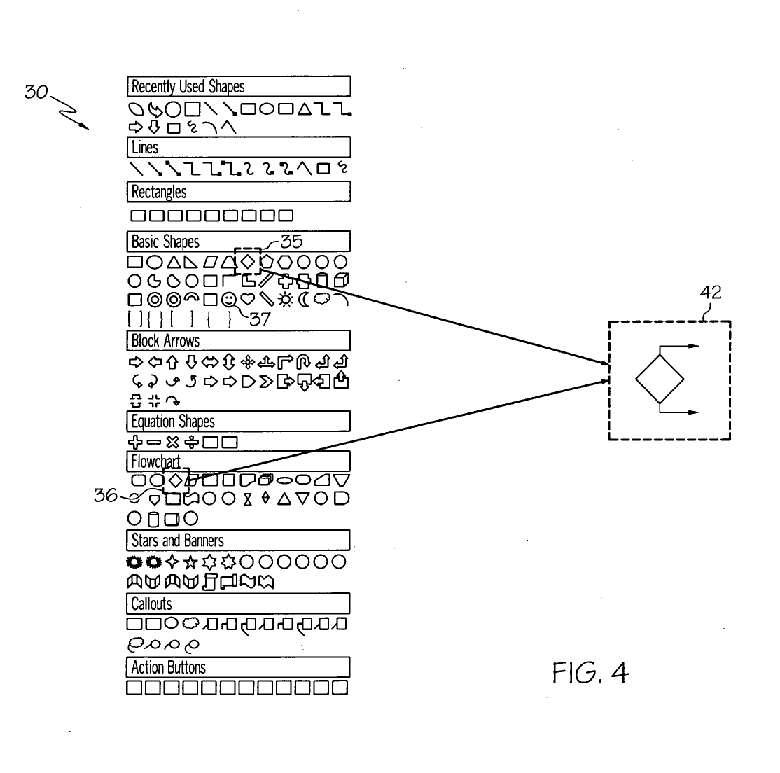

As shown in FIG. 2, a palette 30 including a plurality of shapes and symbols within an informal drawing tool, such as PowerPoint, for example, is shown along with a formal element 40 within the business modeler according to an embodiment of the present invention. As shown in FIG. 2, a set of shapes 31 in the rectangles section and shapes 32 of the flowchart section of the palette 30 are mapped (as indicated by the arrows) to an associated formal element (e.g., a task element 40) within the business modeler. Further, additional examples of configurable mappings between informal elements and formal elements can be seen in FIGS. 3 and 4. For example, in FIG. 3, a shape 33 within the basic shapes section and a shape 34 within the flowchart section of the palette 30 are mapped to an associated formal element e.g., a repository node 41. In FIG. 4, diamond-like shapes 35 and 36 in the basic shapes section and the flowchart section respectively, are mapped to a formal element e.g., a decision node 42 in the business modeler. The mappings are performed by an approximation algorithm which associates the informal elements with a formal element within the business modeler based on proximity of similarity in appearance. According to an embodiment of the present invention, specific mappings are performed such that a plurality of predetermined shapes within the informal drawing tool may be mapped to a single predetermined formal element within the business modeler. According to another embodiment of the present invention, a user may be able to re-map the specific mappings so that unique mappings can be persisted.

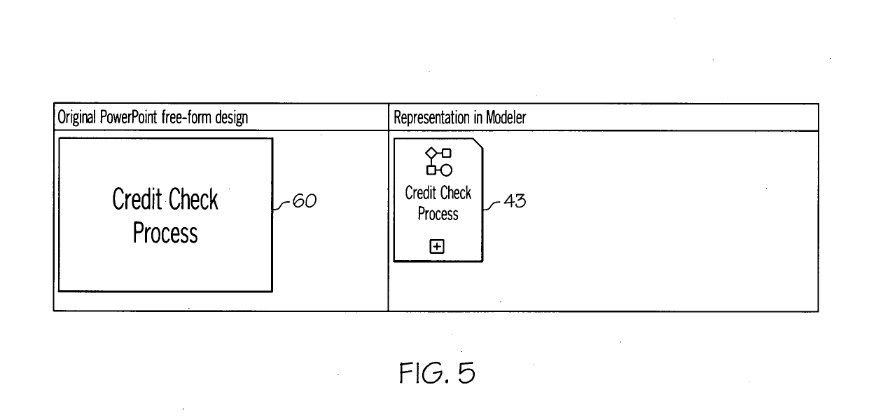

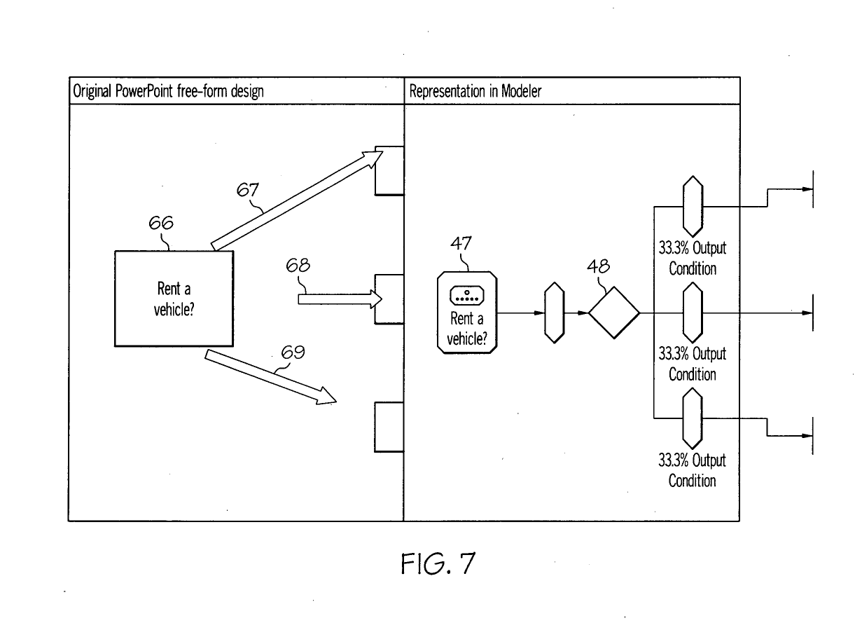

According to another embodiment of the present invention, the business modeler not only recognizes shapes and symbols but also terms and punctuation symbols (described later with reference to FIG. 7) displayed on the informal element, for example. FIG. 5 illustrates another example of a transformation of an informal element within a free-form process diagram to a formal element. As shown in FIG. 5, an informal task element 60 called “a credit check process” of a free-form process diagram is provided. Since the task element includes the term “process” in the label, the business modeler assumes that this node is representing a sub-process of the main process illustrated in the free-form process diagram. This type of inference is a part of a set of pluggable inference rules 52 (as depicted in FIG. 1). According to another embodiment, another inference rule may include determining the mapping based on a position of the term. For example, the term “process” has to appear at the end of the text within the label in order for it to be recognized as a sub-process otherwise it will not be recognized as a sub-process by the business modeler. Therefore, according to the pluggable inference rules 52, in FIG. 5 the “credit check process” is not mapped to a regular task element but to a process element 43 which can be further defined as desired by the user via a graphical user interface (GUI), for example.

Referring back to FIG. 1, in operation 100, when a free-form process diagram to be transformed, is received in the business modeler, the informal elements of the free-form process diagram are automatically detected and mapped to the stored predefined mappings in the mapping knowledge base 50, using predetermined heuristics.

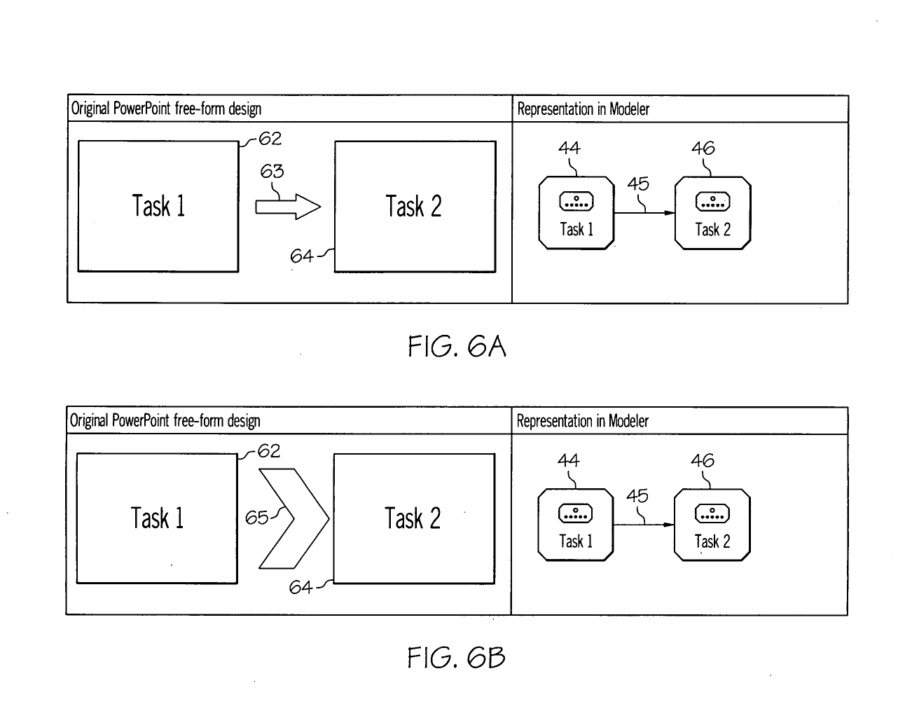

From operation 100, the process moves to operation 110, where connectors between the informal elements of the free-form process diagram are automatically detected and mapped. According to an embodiment of the present invention, the connectors are arrows, for example, which connect one element to another element within the free-form process diagram and the business model. Examples of the detection and mappings of the connectors can be seen at FIGS. 6A, 6B and 7.

In FIG. 6A, two task elements 62 and 64 of a free-form process diagram are provided. An arrow 63 is provided between task elements 62 and 64. In FIG. 6B, task elements 62 and 64 are provided along with an arrow 65 between the task elements 62 and 64. As shown in FIGS. 6A and 6B the arrows 63 and 65 do not make contact with the task elements 62 and 64 within the free-form process diagram. According to an embodiment of the present invention, the business modeler automatically detects and maps these arrows 63 and 65 between the informal elements e.g., task elements 62 and 64 of the free-form process diagram. In one embodiment, in addition to recognizing the task elements 62 and 64 as formal task elements 44 and 46 within the business modeler, using the approximation algorithm, the connectors (e.g., arrows 63 and 65) are detected and mapped to a formal connector e.g., arrows 45, by determining the proximity of the beginning of each arrow 63 and 65 and the end of each arrows 63 and 65 to the nodes e.g., task elements 62 and 64. According to one embodiment, when the connector (i.e., arrow, for example) is in physical contact with the informal elements, for example, task elements 62 and 64, built-in mapping rules 53 (as depicted in FIG. 1, for example) are used to create a formal connector 45. That is, when the source and target make physical contact with the connector, a formal connector is automatically provided. However, when the arrow is not in physical contact with the source and target the following approximation algorithm, according to one embodiment of the present invention, is utilized.

If (shape is an Arrow) {
List possibleStartNodes = getcloseProximityNodes (arrow.start)
List possibleEndNodes = getCloseProximityNodes (arrow.end)
(start, end) = getBestConnectionMatch (possibleStartNodes,
possibleEndNodes)
}

The “getCloseProximityNode” is used to find the closest shapes that are within a given distance to a start or end of an arrow. The threshold where the arrow and the shape are considered in close proximity is determined based on the size of the shape and the relative position and form of the shape. The “getBestConnectionMatch” function is where domain specific heuristics are used to determine which of candidate (start, end) pairs are best matched to be considered as a connection represented by the arrow. According to an embodiment, each heuristic assigns a weight to each pair of (start, end) candidate nodes. These heuristics may include, for example, the distance between the shapes to the arrows, that is, the assigned weight is proportional to the distance (start, arrow.start) to distance (end, arrow.end, and the validity of the connection, for example, discarding the pairs which represent a connection from a terminate node to a task node, or from a task node to a start node. Further, the heuristics may include considering the relative position of the shapes to each other such as when a start shape maps to a decision and the candidate end nodes are located to the right, one above the other (as depicted in FIG. 7, for example). These heuristics are included in the pluggable inference rules 54 (as depicted in FIG. 1). According to one embodiment, based on the heuristics, the informal elements closest in proximity to the connector are selected and the connector is mapped to a formal connector element within the business modeler.

FIG. 7 illustrates another example of transformation of informal task and connector elements to formal elements according to an embodiment of the present invention. In FIG. 7, a task element 66 is provided and has three output branches at indicated by arrows 67, 68 and 69. According to one embodiment, the business modeler recognizes punctuation symbols displayed on the informal element. For example, since the rectangle shape ends with a question mark “?” with more than two outputs, the business modeler recognizes this element as a decision element. Therefore, the task element 66 is mapped to a task element 47 along with a decision element 48 providing three branch decisions of 33.3% equal output conditions. Further, the business modeler detects and maps the connectors i.e., arrows 67, 68 and 69 as described above with reference to FIGS. 6A and 6B.

When the free-form process diagram includes shapes, symbols or terms unrecognizable by the business modeler, the business modeler prompts the user for this information in operation 110 in FIG. 1, where user input is obtained from a user via a graphical user interface, for example, to generate user-defined mappings for unrecognizable informal elements of the free-form process diagram to formal elements. and the unrecognized informal elements of the free-form process diagram are transformed based on the user-defined mappings. According to an embodiment, these user-defined mappings may be stored in the mapping knowledge base 50 as desired by the user for subsequent automated mappings, Therefore, according to an embodiment of the present invention, the mapping knowledge base 50 may obtain more built-in rules over time. The following is an example of an unrecognized informal element. If a symbol such as a smiley face 37 shown in FIG. 4, for example, is included in a free-form process diagram prepared by a user and the built-in map rules 51 may not include a mapping corresponding to the smiley face 37, and the user may be asked via the GUI, to perform a custom mapping and map this element to a formal element within the business modeler. For example, if the smiley face 37 is to represent a task element within the flow-form process diagram, the user may define the smiley face 37 as a task element. According to an embodiment, the user may be prompted to either save the custom mapping for subsequent use or to only use the mapping once.

Embodiments of the present invention use a domain knowledge based heuristic to interpret with a user intended in their free-form process diagram by automatically detecting and mapping informal elements and connectors to formal elements, thereby reducing the need for a business analyst to manually intervene. Additional advantages of the present invention are that it allows the user to continue to model in free-form while still having the full advantage of detailed analysis when translated into a formal business model with the confidence that the original design is accurately and efficiently brought into a semantically rich business model.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

Generally, the method for transforming a free-form process diagram into a semantically rich business model described herein is practiced with a general-purpose computer and the method may be coded as a set of instructions on removable or hard media for use by the general-purpose computer. FIG. 8 is a schematic block diagram of a general-purpose computer suitable for practicing the present invention embodiments. In FIG. 3, computer system 800 has at least one microprocessor or central processing unit (CPU) 805. CPU 805 is interconnected via a system bus 810 to a random access memory (RAM) 815, a read-only memory (ROM) 820, an input/output (I/O) adapter 825 for a connecting a removable data and/or program storage device 830 and a mass data and/or program storage device 835, a user interface adapter 840 for connecting a keyboard 845 and a mouse 850, a port adapter 855 for connecting a data port 860 and a display adapter 865 for connecting a display device 870.

ROM 820 contains the basic operating system for computer system 300. The operating system may alternatively reside in RAM 815 or elsewhere as is known in the art. Examples of removable data and/or program storage device 830 include magnetic media such as floppy drives and tape drives and optical media such as CD ROM drives. Examples of mass data and/or program storage device 835 include hard disk drives and non-volatile memory such as flash memory. In addition to keyboard 845 and mouse 850, other user input devices such as trackballs, writing tablets, pressure pads, microphones, light pens and position-sensing screen displays may be connected to user interface 840. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 830, fed through data port 860 or typed in using keyboard 845.

In view of the above, the present method embodiment may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method for transforming a free-form process diagram into a semantically rich business model based on heuristics, the method comprising:
generating and storing predefined mappings between informal elements to be used in a free-form process diagram and formal elements associated with a semantically rich business model, in a storage medium;
receiving a free-form process diagram to be transformed;
automatically detecting and mapping the informal elements of the free-form process diagram to the stored predefined-mappings;
automatically detecting and mapping connectors positioned between the informal elements of the free-form process diagram; and
obtaining user input from a user for generating user-defined mappings for mapping unrecognizable informal elements of the free-form process diagram to formal elements and transforming the unrecognized informal elements into formal elements based on the user-defined mappings.

2. The computer-implemented method of claim 1, wherein generating and storing predefined mappings comprises:
mapping at least one informal element to at least one formal element.

3. The computer-implemented method of claim 2, wherein the mapping is performed based on a proximity to similarity in appearance between the at least one informal element and the at least one formal element.

4. The computer-implemented method of claim 2, wherein the mapping is performed based on a term displayed on the informal element within the free-form process diagram and the position of the term based on predetermined heuristics.

5. The computer-implemented method of claim 2, wherein the mapping is performed based on a punctuation symbol displayed on the informal element within the free-form process diagram.

6. The computer-implemented method of claim 1, wherein automatically detecting and mapping connectors positioned between informal elements of the free-form process diagram comprises:
determining a proximity of a beginning of a connector and an end of the connector, to the informal elements, to determine which informal elements are closest in proximity to the connector based on the determined proximity.

7. The computer-implemented method of claim 6, wherein a threshold for determining the proximity is based on at least one of a size, relative position and shape of the informal element.

8. The computer-implemented method of claim 7, wherein the informal elements closest in proximity to the connector are selected and the connector is mapped to a formal connector element based on predetermined heuristics.

9. The computer-implemented method of claim 8, wherein the predetermined heuristics include at least one of a distance between the informal elements to the connector, a validity of a connection between the informal elements, and a relative position of the informal elements to each other.

10. The computer-implemented method of claim 1, further comprising:
storing the user-defined mappings in the storage medium for subsequent mappings as desired by the user.

11. A computer program product comprising a computer useable medium including a computer readable program, wherein the computer readable program when executed on a computer causes the computer to implement a method of transforming a free-form process diagram into a semantically rich business model based on heuristics, the method comprising:
generating and storing predefined mappings between informal elements to be used in a free-form process diagram and formal elements associated with a semantically rich business model, in a storage medium;
receiving a free-form process diagram to be transformed;
automatically detecting and mapping the informal elements of the free-form process diagram to the stored predefined-mappings;
automatically detecting and mapping connectors positioned between the informal elements of the free-form process diagram; and
obtaining user input from a user for generating user-defined mappings for mapping unrecognizable informal elements of the free-form process diagram to formal elements and transforming the unrecognized informal elements into formal elements based on the user-defined mappings.

12. The computer program product of claim 11, wherein generating and storing predefined mappings comprises:
mapping at least one informal element to at least one formal element.

13. The computer program product of claim 12, wherein the mapping is performed based on a proximity to similarity in appearance between the at least one informal element and the at least one formal element.

14. The computer program product of claim 12, wherein the mapping is performed based on a term displayed on the informal element within the free-form process diagram and the position of the term based on predetermined heuristics.

15. The computer program product of claim 12, wherein the mapping is performed based on a punctuation symbol displayed on the informal element within the free-form process diagram.

16. The computer program product of claim 11, wherein automatically detecting and mapping connectors positioned between informal elements of the free-form process diagram comprises:
determining a proximity of a beginning of a connector and an end of the connector, to the informal elements, to determine which informal elements are closest in proximity to the connector based on the determined proximity.

17. The computer program product of claim 16, wherein a threshold for determining the proximity is based on at least one of a size, relative position and shape of the informal element.

18. The computer program product of claim 17, wherein the informal elements closest in proximity to the connector are selected and the connector is mapped to a formal connector element based on predetermined heuristics.

19. The computer program product of claim 18, wherein the predetermined heuristics include at least one of a distance between the informal elements to the connector, a validity of a connection between the informal elements, and a relative position of the informal elements to each other.

20. The computer-implemented method of claim 11, further comprising:
storing the user-defined mappings in the storage medium for subsequent mappings as desired by the user.
